(19) United States
(12) Patent Application Publication
(10) Pub. No.: US 2022/0129830 A1
(43) Pub. Date: Apr. 28, 2022

(54) SYSTEM, CONTROL METHOD, AND STORAGE MEDIUM

(71) Applicant: CANON KABUSHIKI KAISHA, Tokyo (JP)

(72) Inventor: Kosuke Saito, Tokyo (JP)

(21) Appl. No.: 17/508,796

(22) Filed: Oct. 22, 2021

(30) Foreign Application Priority Data
Oct. 26, 2020 (JP) 2020-178931

(51) Int. Cl. G06Q 10/08; G06Q 10/06; G06Q 10/04

(52) U.S. Cl. CPC G06Q 10/083; G06Q 10/087; G06Q 10/04; G06Q 10/063114

(57) ABSTRACT

A system outputs an estimated price and an estimated delivery date in a case where an article is manufactured in a facility, based on order information about the article, an operation status of the facility used to manufacture the article, and a status of an employee to engage in the manufacturing of the article.

### BACKGROUND

### Field

The present disclosure relates to a system for estimating a manufacturing cost and a delivery date of an article, a control method therefor, and a storage medium.

### Description of the Related Art

Heretofore, experts have estimated a manufacturing cost and a delivery date of an article in consideration of functional information, such as the shape, dimensional tolerance, and material of the article. Japanese Patent Application Laid-Open No. 2019-32623 discusses a system for estimating the price and delivery date of an estimation target article based on a three-dimensional (3D) model for the article and the specifications of the article by using trained models.

However, in the system discussed in Japanese Patent Application Laid-Open No. 2019-32623, the operation status of each facility and the status of each employee are not taken into consideration, which may lead to deterioration in estimation accuracy.

### SUMMARY

In view of the above-described issues, among others, various embodiments of the present disclosure are directed to providing a technique for accurately estimating a manufacturing cost or a delivery date of an article.

According to various embodiments of the present disclosure, a system includes an acquisition unit and an output unit. The acquisition unit acquires order information about an article, information for identifying an operation status of a facility used to manufacture the article, and information for identifying a status of an employee to engage in the manufacturing of the article. The output unit outputs information indicating an estimated price and an estimated delivery date in a case where the article is manufactured in the facility based on the order information about the article, the information for identifying the operation status of the facility used to manufacture the article, and the information for identifying the status of the employee to engage in the manufacturing of the article. The order information, the information for identifying the operation status, and the information for identifying the status of the employee are acquired by the acquisition unit.

Further features of the present disclosure will become apparent from the following description of example embodiments with reference to the attached drawings.

### BRIEF DESCRIPTION OF THE DRAWINGS

FIG. 1 is a block diagram illustrating a configuration example of a system according to an example embodiment of the present disclosure.

FIG. 2 is a block diagram illustrating a learning apparatus for a process candidate calculation unit according to the example embodiment.

FIG. 3 is a block diagram illustrating an inference apparatus for the process candidate calculation unit according to the example embodiment.

FIG. 4 is a block diagram illustrating a learning apparatus for an acceptable price/delivery date estimation unit according to the example embodiment.

FIG. 5 is a block diagram illustrating an inference apparatus for the acceptable price/delivery date estimation unit according to the example embodiment.

FIG. 6 is a block diagram illustrating a process/schedule calculation apparatus according to the example embodiment.

FIG. 7 is a flowchart illustrating process/schedule calculation processing according to the example embodiment.

FIG. 8 is a block diagram illustrating an estimation calculation apparatus according to the example embodiment.

FIG. 9 illustrates an example of a computer-aided design (CAD) model according to an application example.

FIG. 10 is a table illustrating an example of order information according to an application example.

FIG. 11 is a table illustrating an example of constraint conditions according to an application example.

FIG. 12 illustrates an example of a facility operating schedule according to an application example.

FIG. 13 illustrates an example of an employee schedule according to an application example.

FIG. 14 illustrates an example of a required time for each process candidate pattern, each process pattern, and each process according to an application example.

FIG. 15 is a graph illustrating an example of an acceptable price/delivery date estimation unit model according to an application example.

FIG. 16 is a block diagram illustrating a hardware configuration example of a system according to the example embodiment.

FIGS. 17A and 17B are flowcharts illustrating a series of processing flows of learning and inference processing to be performed by the process candidate calculation unit according to an example embodiment.

FIGS. 18A and 18B are flowcharts illustrating a series of processing flows of learning and inference processing to be performed by the acceptable price/delivery date estimation unit according to an example embodiment.

### DESCRIPTION OF THE EMBODIMENTS

Various embodiments for carrying out features of the present disclosure will be described below with reference to the drawings. The following example embodiments are to serve as examples only, and are not intended to limit the scope of the present invention. Further, not all combinations of features described in the example embodiments are essential to every embodiment of solving means of the present disclosure. Embodiments of the present invention can depart from the described example embodiments as appropriate without departing from the scope of the present invention.

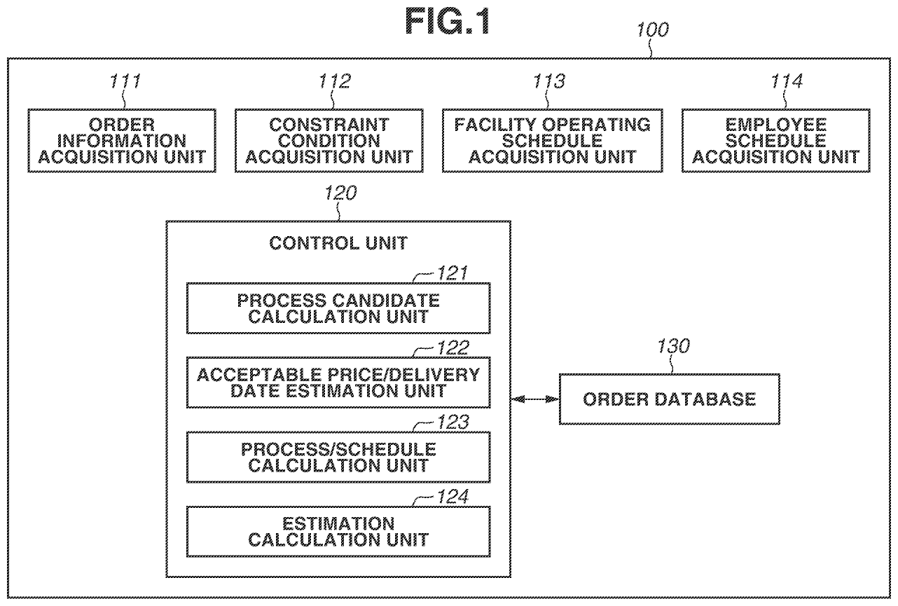

FIG. 1 is a block diagram illustrating a configuration example of an article manufacturing cost and delivery date estimation system 100 (hereinafter referred to as a system 100) according to an example embodiment of the present disclosure. The system 100 calculates an estimated price and an estimated delivery date for manufacturing an article based on information about an order received from a customer, constraint conditions in a factory, the operation status of each facility in the factory, and the status of each employee who engages in manufacturing of the article in the factory. Examples of the article include a component and an object assembled using components. Examples of the facility include an article processing apparatus and an article manufacturing apparatus. Examples of the facility also include a grinding apparatus, a welding apparatus, and a crimping apparatus. Examples of the status of each employee include a schedule for each employee. The schedule may include not only the future schedule, but also the past schedule. This is because the status of an employee, such as working hours and fatigue levels (physical conditions) can be estimated, for example, based on the past schedule of the employee. Examples of the status of each employee may include working hours and fatigue levels (physical conditions). The operation status may include an operating schedule, and the schedule may include not only the future schedule, but also the past schedule.

The system 100 includes a customer order information acquisition unit 111, a factory constraint condition acquisition unit 112, a factory facility operating schedule acquisition unit 113, a factory employee schedule acquisition unit 114, a control unit 120, and an order database 130. The control unit 120 includes a process candidate calculation unit 121, an acceptable price/delivery date estimation unit 122, a process/schedule calculation unit 123, and an estimation calculation unit 124. The control unit 120 is connected to the order database 130 in which order information indicating that an estimation request is previously received from a customer is stored. The system 100 may be composed of one or more apparatuses.

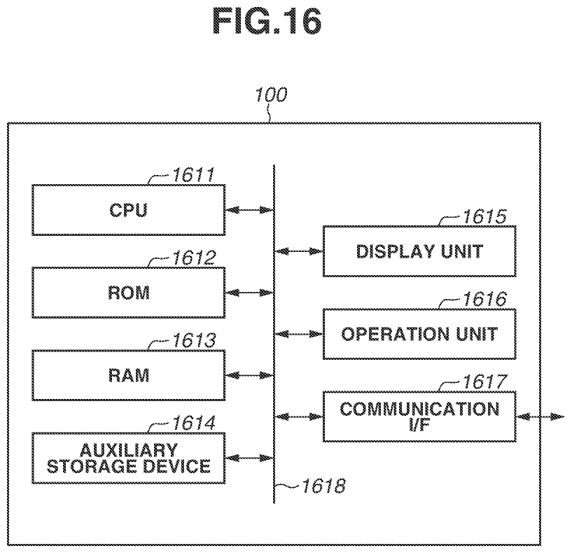

A hardware configuration example of the system 100 will be described with reference to FIG. 16. FIG. 16 illustrates an example where the system 100 is composed of a single apparatus. The system 100 includes a central processing unit (CPU) 1611, a read-only memory (ROM) 1612, a random access memory (RAM) 1613, an auxiliary storage device 1614, a display unit 1615, an operation unit 1616, a communication interface (I/F) 1617, and a bus 1618.

The CPU 1611 controls the overall operation of the system 100 by using computer programs and data stored in the ROM 1612 or the RAM 1613, thereby implementing the functions of the system 100 illustrated in FIG. 1. The system 100 may include one or more dedicated hardware modules different from the CPU 1611, and the dedicated hardware modules may execute at least a part of the processing to be executed by the CPU 1611. Examples of the dedicated hardware modules include an application specific integrated circuit (ASIC), a field-programmable gate array (FPGA), and a digital signal processor (DSP). The ROM 1612 stores, for example, programs that need not to be changed. The RAM 1613 temporarily stores, for example, programs and data supplied from the auxiliary storage device 1614, and data supplied from an external apparatus via the communication I/F 1617. The auxiliary storage device 1614 is composed of, for example, a hard disk drive, and stores various data such as image data.

The display unit 1615 is composed of, for example, a liquid crystal display or a light-emitting diode (LED). The display unit 1615 displays, for example, a graphical user interface (GUI) for a user to operate. The operation unit 1616 is composed of, for example, a keyboard, a mouse, and a touch panel. The operation unit 1616 receives operations performed by the user and inputs various instructions to the CPU 1611. The CPU 1611 operates as a display control unit that controls the display unit 1615 and an operation control unit that controls the operation unit 1616.

The communication I/F 1617 is used for communication between the system 100 and an external apparatus. For example, when the system 100 is connected to an external apparatus with a wire, a communication cable is connected to the communication I/F 1617. When the system 100 includes a function for establishing a wireless communication with an external apparatus, the communication I/F 1617 includes an antenna. The bus 1618 connects the units included in the system 100 to transmit information.

In the present example embodiment, the display unit 1615 and the operation unit 1616 are located in the system 100, but instead at least one of the display unit 1615 and the operation unit 1616 may be located outside the system 100 as a separate apparatus.

When the system 100 is composed of a plurality of apparatuses, each apparatus may include a hardware configuration similar to the hardware configuration illustrated in FIG. 16. The plurality of apparatuses may include an apparatus that does not include the elements illustrated in FIG. 16, such as the display unit 1615, or may include an apparatus that further includes another element. For example, an apparatus having the function of the order information acquisition unit 111 may include a scanner or a camera (image sensor) for scanning and importing order information printed on a printed material such as paper. The plurality of apparatuses may also include an apparatus having a microphone (sound pickup device) to handle an audio input.

The order information acquisition unit 111 acquires information for identifying order information. The order information is information about at least one of an orderer, an estimated component, and an estimated product. Specific examples of the order information include data on a computer-aided design (CAD) model representing the shape of a component, component functional information, a company name, a desired price, a desired delivery date, a price priority, a delivery date priority, and a customer importance. The order information acquisition unit 111 may acquire these pieces of data from an external apparatus via the communication I/F 1617, or may acquire these pieces of data by a user operation through the operation unit 1616.

The constraint condition acquisition unit 112 acquires information for identifying constraint conditions. The constraint conditions are conditions for facilities and the like owned by a person who has received an order, and are conditions that affect the price and estimation in manufacturing of a component or the like. Examples of the constraint conditions include information indicating a correspondence between a process and a facility, such as a conditional facility, a facility capability, information indicating a correspondence between an employee and a process, an employee operation capability, a cost per unit time of each facility, and a cost per unit time of each employee. Examples of the constraint conditions also include the recent labor status of each employee. The facility capability may be obtained by quantifying, for example, a manufacturing speed and a production yield. The employee operation capability may be quantified. The constraint condition acquisition unit 112 may acquire the constraint conditions as data from an external apparatus via the communication I/F 1617, or may acquire the data by a user operation through the operation unit 1616.

The facility operating schedule acquisition unit 113 acquires the current and future schedules for each facility. The facility operating schedule includes a facility maintenance schedule. This schedule may be managed in units of minutes, hours, or days. The facility operating schedule acquisition unit 113 may acquire these pieces of data from an external apparatus via the communication I/F 1617, or may acquire these pieces of data by a user operation through the operation unit 1616. The facility operating schedule acquisition unit 113 may acquire data on an Internet of Things (IoT) apparatus to reflect the operation status varying in real time in the schedule. The facility operating schedule acquisition unit 113 may periodically acquire the facility operation status, or may acquire the facility operation status on an irregular basis.

The employee schedule acquisition unit 114 acquires a work schedule and a work plan for each employee. This schedule may be managed in units of minutes, hours, or days. The employee schedule acquisition unit 114 may acquire these pieces of data from an external apparatus via the communication I/F 1617, or may acquire these pieces of data by a user operation through the operation unit 1616. The employee schedule acquisition unit 114 may acquire data on an IoT apparatus (e.g., a monitoring camera, and a beacon) to reflect the employee operation status varying in real time in the schedule. The employee schedule acquisition unit 114 may periodically acquire the facility operation status, or may acquire the facility operation status on an irregular basis.

The control unit 120 calculates an estimated price and an estimated delivery date for manufacturing a component. For this purpose, the control unit 120 acquires the order information acquired by the order information acquisition unit 111 and the constraint conditions acquired by the constraint condition acquisition unit 112. The control unit 120 also acquires the facility operating schedule acquired by the facility operating schedule acquisition unit 113 and the employee schedule acquired by the employee schedule acquisition unit 114. The control unit 120 calculates the estimated price and the estimated delivery date for manufacturing the component based on the acquired information.

As described above, the control unit 120 includes the process candidate calculation unit 121, the acceptable price/delivery date estimation unit 122, the process/schedule calculation unit 123, and the estimation calculation unit 124.

The process candidate calculation unit 121 outputs a process candidate based on information for identifying order information. Specifically, the process candidate calculation unit 121 receives information for identifying order information and outputs a process candidate by using a learning result (trained model). The process candidate calculation unit 121 may be a process candidate calculation unit inference apparatus including a trained model, or may be a trained model included in the process candidate calculation unit inference apparatus. The following example illustrates a case where the process candidate calculation unit 121 is a process candidate calculation unit inference apparatus including a trained model.

The acceptable price/delivery date estimation unit 122 outputs an acceptable price/delivery date range based on information for identifying a desired price and a desired delivery date for each company. Specifically, the acceptable price/delivery date estimation unit 122 receives the information for identifying the desired price and the desired delivery date and outputs the acceptable price/delivery date range by using, for example, the learning result (trained model). The acceptable price/delivery date estimation unit 122 may be an acceptable price/delivery date estimation unit inference apparatus including a trained model, or may be a trained model included in the acceptable price/delivery date estimation unit inference apparatus. The following example illustrates a case where the acceptable price/delivery date estimation unit 122 is an acceptable price/delivery date estimation unit inference apparatus including a trained model. A range is output as the acceptable price and the acceptable delivery date.

The process/schedule calculation unit 123 uses various data and outputs candidates for the estimated price and delivery date, the process, and the facility operating schedule and employee schedule corresponding to the process. Specific examples of the various data include data on constraint conditions, a process candidate pattern calculated by the process candidate calculation unit 121, and data on an acceptable price/delivery date estimated width estimated by the acceptable price/delivery date estimation unit 122. Additionally, the order information, the facility operating schedule, the employee schedule, and component delivery date buffer data are acquired.

The estimation calculation unit 124 outputs the estimated price based on the various data. The various data include information indicating a correspondence between a facility and a process, information indicating a correspondence between an employee and a process, data on a cost per unit time of each facility, and data on a cost per unit time of each employee, which are obtained by the constraint condition acquisition unit 911.

A learning phase and an estimation phase of the process candidate calculation unit 121 will now be described in detail. Specific examples of a learning algorithm include a nearest neighbor algorithm, a naive Bayes method, a decision tree, and a support vector machine. Specific examples of the learning algorithm also include deep learning for generating a feature amount for learning and a connection weighting coefficient by using a neural network. The above-described available algorithms can be appropriately used and applied to the present example embodiment. A case where a neural network is used will be described below by way of example.

### Learning Phase of Process Candidate Calculation Unit

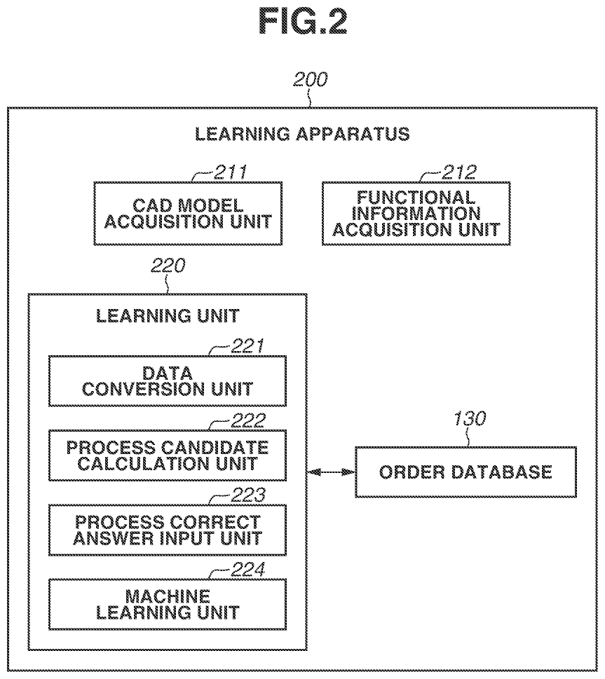

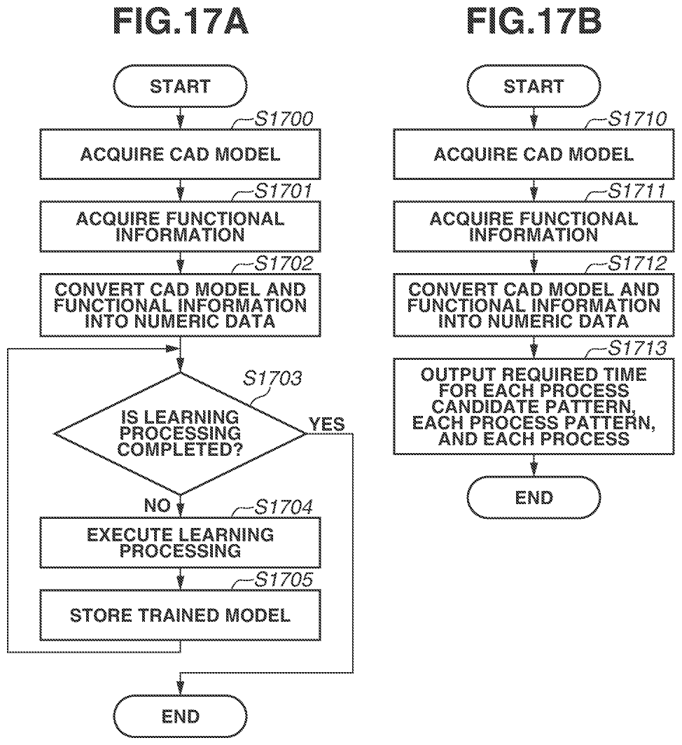

FIG. 2 is a block diagram illustrating a configuration example of a process candidate calculation unit learning apparatus 200 for learning the process candidate calculation unit 121. The process candidate calculation unit 121 may be a trained model generated by the process candidate calculation unit learning apparatus 200, or may be the process candidate calculation unit learning apparatus 200 itself. FIG. 17A illustrates a series of processing flows of learning processing to be performed by the process candidate calculation unit 121.

The process candidate calculation unit learning apparatus 200 includes a CAD model acquisition unit 211, a functional information acquisition unit 212, a learning unit 220, and the order database 130. The learning unit 220 includes a data conversion unit 221, a process candidate calculation unit 222, a process correct answer input unit 223, and a machine learning unit 224. The process candidate calculation unit learning apparatus 200 is connected to the order database 130 in which order information indicating that an estimation request is previously received from a customer is stored.

In step S1700, the CAD model acquisition unit 211 acquires a CAD model stored in the order database 130 that represents the shape of a component. In this case, the CAD model is a three-dimensional model generated by a three-dimensional CAD, and is an example of shape data indicating the shape of a component. Various file formats, such as Initial Graphics Exchange Specification (IGES) and Precomputed Radiance Transfer (PRT), can be used for the CAD model, and any file format may be adopted. The CAD model acquisition unit 211 may acquire two-dimensional shape data on the component when the component is viewed from a plurality of directions, or a two-dimensional design drawing.

In step S1701, the functional information acquisition unit 212 acquires the component functional information acquired by the CAD model acquisition unit 211. In this case, the functional information includes functional characteristics of a product for which the component is used, functional characteristics of the component, a product design, a component design, appearance characteristics, an appearance step, an appearance variance, a drawing tolerance, component rigidity/deformation, a resin shrinkage, a product size, a component thickness, assembly information, and material. All or some of these pieces of information may be used as information used for learning.

In step S1702, the learning unit 220 receives, as input data for learning, the component CAD model acquired by the CAD model acquisition unit 211 and the functional information acquired by the functional information acquisition unit 212, and the data conversion unit 221 converts the input data into numeric data. Specifically, the data conversion unit 221 converts the component CAD model into point group data. The term “point group data” used herein refers to data indicating a three-dimensional object represented by a CAD model as a set of points. The point group data is represented as coordinate data using x, y, and z coordinates. The point group data is not limited to coordinate data, but instead data indicating a normal vector to each point may be held. As a method for converting the CAD model into point group data, for example, the CAD model may be stored as stereolithography (STL) data, and coordinates of a vertex of a triangle patch of STL data and a normal vector may be extracted as point group data. It may be preferable to use a larger number of point groups in the point group data to more closely represent the shape of the component. However, there are constraints on resources, such as a memory, in computer processing, and thus the maximum number of point groups is determined based on the constraints on resources for the processing. The component CAD model is not limited to point group data, but instead may be image data captured from multiple viewpoints, or voxel data.

When the functional information is identical in the entire component, the data conversion unit 221 converts the functional information into a single piece of numeric data. In contrast, when the functional information varies depending on a portion constituting the component, the data conversion unit 221 converts the functional information into numeric data for each point, each pixel, or each voxel of a CAD model point group, an image, or voxel data. For example, the component rigidity/deformation and the resin shrinkage are information that is identical in the entire component. Thus, the functional information is converted into a single piece of numeric data. In contrast, the appearance step and the appearance characteristics (e.g., embossed or non-embossed) are information that varies depending on a portion constituting the component. The functional information is thus converted into numeric data corresponding to each point in the point group data of the CAD model. As a method for representing numeric values, so-called label representation, One-Hot vector representation, or the like may be adopted. However, the method is not limited to these examples.

In step S1703, the learning unit 220 determines whether the learning processing is completed. Specifically, the learning unit 220 determines whether the processing described below on all pieces of learning data is completed. If the learning processing is completed (YES in step S1703), the processing is terminated. If the learning processing is not completed (NO in step S1703), the learning processing is continued.

The process candidate calculation unit 222 includes a neural network (learning model) having an input layer, an intermediate layer, and an output layer. In step S1704, data output from the data conversion unit 221 is first input to the input layer, and a candidate for a process pattern and data corresponding to a required time for each process in the process pattern are output from the output layer. In this case, the candidate for the process pattern is a combination of processes, such as process A→process B→process C, or process B→process D, and all possible patterns are registered in advance.

The process correct answer input unit 223 uses actual data (an actual process pattern and a required time for each process) stored in the order database 130 as correct answer data, and compares the actual data with the process pattern candidate and the required time for each process, which are output from the process candidate calculation unit 222.

The machine learning unit 224 updates a connection weighting coefficient or the like between nodes in the neural network of the process candidate calculation unit 222 based on the difference obtained after the comparison by the process correct answer input unit 223 so that the difference can be decreased. In this update processing, for example, the connection weighting coefficient or the like may be updated by a back propagation method. The back propagation method is a method of adjusting the connection weighting coefficient or the like between nodes of the neural network so that the above-described difference can be decreased. In step S1705, the generated trained model is stored.

The above-described processing is repeatedly executed a number of times corresponding to the number of pieces of order information. The neural network used as a learning model may be a convolutional neural network.

The process candidate calculation unit 222 is thus trained and the process candidate calculation unit 222 includes a trained model. The process candidate calculation unit 222 can be used as the process candidate calculation unit 121 illustrated in FIG. 1. An inference phase of the process candidate calculation unit 121 will be described in detail below.

Table 1 illustrates an example of learning data (pairs of input data and correct answer data). The input data is represented as converted numeric data. The point group data is represented by a file in which points represented by xyz coordinates are described. The functional information may include information other than the information illustrated in Table 1 as described above, or may include information less than the information illustrated in Table 1.

Processes to be output from the learning model may be numeric data. For example, numeric values corresponding to process A→process B→process C may be set in advance. Further, in the learning model, processes may be output depending on the correspondence relationship between processes and numeric values respectively corresponding to the processes.

TABLE 1

| | Input Data | | | | | | | | | Correct Answer Data | |
|---|---|---|---|---|---|---|---|---|---|---|---|
| | Point | | | | | Component | | | | Actual | Actual |
| ID | Group | Component | Appearance | Appearance | Appearance | Rigidity/ | Resin | Component | | Process | Required |
| No. | Data | Design | Characteristics | Step | Variance | deformation | Shrinkage | Thickness | Material | Pattern | Time |
| 0001 | A | 0001 | 0004 | 0010 | 0005 | 0006 | 0110 | 0020 | 0001 | A → B → C | 1110 |
| 0002 | B | 0003 | 0001 | 0010 | 0004 | 0001 | 0056 | 0035 | 0005 | B → D | 60 |

. . .

| | | | | | | | | | | | |
|---|---|---|---|---|---|---|---|---|---|---|---|
| 000N | N | 0300 | 0450 | 0050 | 0010 | 0080 | 0040 | 0010 | 0060 | F → B | 80 |

A graphics processing unit (GPU) can perform effective calculations by performing parallel processing on a larger number of pieces of data. Thus, it is effective to use the GPU to perform processing when learning processing is executed a plurality of times using a learning model such as deep learning. The GPU may be used instead of the CPU in the learning processing. Specifically, in the case of executing a learning program including a learning model, the learning processing is performed by calculations using the CPU and the GPU in cooperation. In the learning processing, calculations may be performed using only one of the CPU and the GPU. The GPU may be used also in the subsequent estimation processing.

### Inference Phase of Process Candidate Calculation Unit

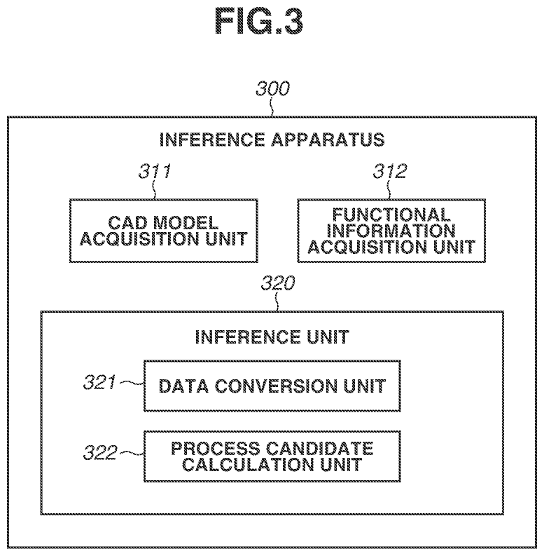

FIG. 3 is a block diagram illustrating a functional configuration of a process candidate calculation unit inference apparatus 300 corresponding to the process candidate calculation unit 121 according to the present example embodiment. The process candidate calculation unit inference apparatus 300 includes a CAD model acquisition unit 311, a functional information acquisition unit 312, and an inference unit 320. The inference unit 320 includes a data conversion unit 321 and a process candidate calculation unit 322. FIG. 17B illustrates a series of processing flows of inference processing to be performed by the process candidate calculation unit 121.

In step S1710, the CAD model acquisition unit 311 in the process candidate calculation unit inference apparatus 300 acquires a CAD model representing the shape of a component for which an estimation order is received. In this case, the CAD model is a three-dimensional model generated by a three-dimensional CAD, and is an example of shape data representing the shape of a component. Various file formats, such as IGES and PRT, can be used for the CAD model, and any file format may be adopted. The CAD model acquisition unit 311 may acquire two-dimensional shape data on the component when the component is viewed from a plurality of directions, or a two-dimensional design drawing.

In step S1711, the functional information acquisition unit 312 acquires the component functional information acquired by the CAD model acquisition unit 311. In this case, the functional information includes functional characteristics of a product for which the component is used, functional characteristics of the component, a product design, a component design, appearance characteristics, an appearance step, an appearance variance, a drawing tolerance, component rigidity/deformation, a resin shrinkage, a product size, a component thickness, assembly information, and material. The functional information need not include all of these pieces of information, but instead may include only some of the pieces of information. The functional information may include information other than the information described above by way of example.

In step S1712, the data conversion unit 321 in the inference unit 320 converts the acquired CAD model into point group data and converts the functional information into numeric data, similarly to the data conversion unit 221 included in the process candidate calculation unit learning apparatus 200.

The process candidate calculation unit 322 includes the trained model generated by the process candidate calculation unit 222. The data output from the data conversion unit 221 is therefore input to the input layer in the trained model of the process candidate calculation unit 322. In step S1713, the process candidate pattern and the required time for each process pattern and each process are thereby output from the output layer. Thus, the process candidate calculation unit 121 illustrated in FIG. 1 outputs the required time for each process candidate pattern, each process pattern, and each process corresponding to an estimation target product.

The learning phase and the inference phase of the acceptable price/delivery date estimation unit 122 will now be described in detail. Specific examples of the learning algorithm include a nearest neighbor algorithm, a naive Bayes method, a decision tree, and a support vector machine. Specific examples of the learning algorithm also include deep learning for generating a feature amount for learning and a connection weighting coefficient by using a neural network. The above-described available algorithms can be appropriately used and applied to the present example embodiment. A case where a neural network is used will be described below by way of example.

### Learning Phase of Acceptable Price/Delivery date Estimation Unit

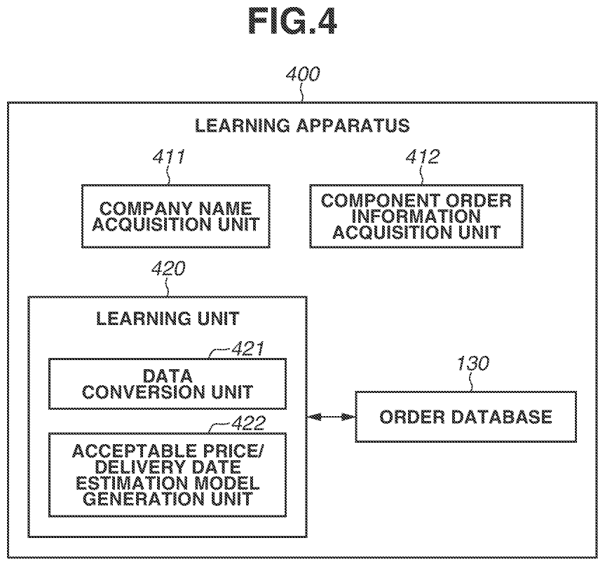

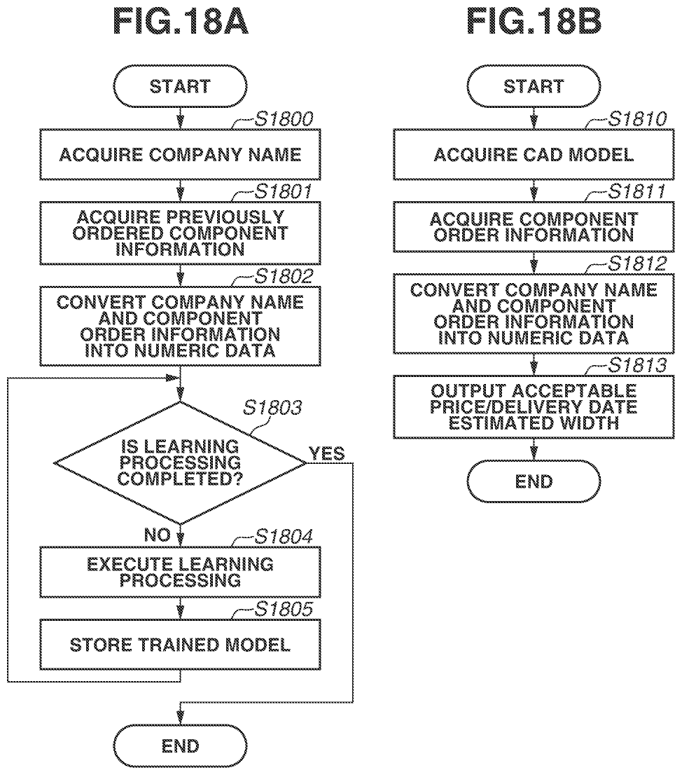

FIG. 4 is a block diagram illustrating a functional configuration of an acceptable price/delivery date estimation unit learning apparatus 400 for learning the acceptable price/delivery date estimation unit 122. The acceptable price/delivery date estimation unit 122 may be a trained model generated by the acceptable price/delivery date estimation unit learning apparatus 400, or may be the acceptable price/delivery date estimation unit learning apparatus 400 itself. FIG. 18A is a flowchart illustrating a series of processing flows of learning processing to be performed by the acceptable price/delivery date estimation unit 122.

The acceptable price/delivery date estimation unit learning apparatus 400 includes a company name acquisition unit 411, a component order information acquisition unit 412, a learning unit 420, and the order database 130. The learning unit 420 includes a data conversion unit 421 and an acceptable price/delivery date estimation model generation unit 422. The acceptable price/delivery date estimation unit learning apparatus 400 is connected to the order database 130 in which order information indicating that an estimation request is previously received from a customer is stored.

In step S1800, the company name acquisition unit 411 acquires a company name of a company from which an order has previously been received. The company name is stored in the order database 130. The company name acquisition unit 411 may acquire identification information corresponding to the company name.

In step S1801, the component order information acquisition unit 412 acquires information about the component for which an order is previously received for each company whose name is acquired by the company name acquisition unit 411. In this case, the order information includes a desired price, a desired delivery date, information indicating whether an order is received, a responded price, a responded delivery date, an accepted price, an accepted delivery date, and a reason for failure to receive an order for each component.

In step S1802, the data conversion unit 421 in the learning unit 420 converts, into numeric data, the company name (identification information) acquired by the company name acquisition unit 411 and the component order information acquired by the component order information acquisition unit 412. Specifically, the data conversion unit 421 converts the acquired data into numeric data preliminarily set depending on the company name (identification information). The data conversion unit 421 outputs the numeric data for each item of the component order information depending on the contents of the item. More specifically, the output of the numeric data include the numeric data corresponding to the contents of a desired price, a desired delivery date, information indicating whether an order is received, a responded price, a responded delivery date, an accepted price, an accepted delivery date, and a reason for failure to receive an order for each component. As for the price and delivery date, numerical values indicating the price and delivery date may be output. The order information used as input data may include all or some of the above-described information.

An expected price at which the order may have been received and an expected delivery date for which the order may have been received may be inferred based on the reason for failure to receive the order, and the expected price and the expected delivery date may be output as numeric data. If an order has not been received from the company because of the price, the expected price at which the order may have been received may be set to be lower than the responded price. If an order has not been received from the company because of the delivery date, the expected delivery date for which the order may have been received may be set to be earlier than the responded delivery date.

In step S1803, the acceptable price/delivery date estimation model generation unit 422 determines whether the learning processing is completed. Specifically, the acceptable price/delivery date estimation model generation unit 422 determines the processing described below is completed on all pieces of learning data. If the learning processing is completed (YES in step S1803), the processing is terminated. If the learning processing is not completed (NO in step S1803), the learning processing is continued.

A trained model may be used as an acceptable price/delivery date estimation model. To generate this model, machine learning can be used, such as logistic regression, a support vector method (SVM), or a neural network. A case will be described by way of example where the acceptable price/delivery date estimation model includes a neural network having an input layer, an intermediate layer, and an output layer. In step S1804, the data corresponding to a desired price and a desired delivery date for each component output from the data conversion unit 221 may be input to the input layer, and the data corresponding to the acceptable price/delivery date may be output. The data corresponding to the acceptable price/delivery date to be output is compared with the accepted price or the expected price at which the order may have been received if the order has failed to be received by the company, and with the accepted delivery date or the expected delivery date for which the order may have been received if the order has failed to be received by the company. These prices and delivery dates to be compared are obtained by the conversion processing performed by the data conversion unit 421. Based on the difference obtained by the comparison, the connection weighting coefficient or the like between nodes of the neural network of the acceptable price/delivery date estimation model is updated so that the difference can be decreased. In the update processing, for example, the back propagation method may be used. In step S1805, the trained model generated as described above is stored.

The above-described processing is repeatedly executed a number of times corresponding to the number of pieces of order information. The neural network used as a learning model may be a convolutional neural network.

The acceptable price/delivery date estimation model generation unit 422 generates the acceptable price/delivery date estimation model for each company. The acceptable price/delivery date estimation model may be defined by two axes respectively representing a value obtained by dividing a responded or accepted price by a desired price and a value obtained by subtracting a responded or accepted delivery date from a desired delivery date. A boundary between a case of receiving an order and a case of failing to receive an order may be determined based on data stored in the order database 130. The acceptable price/delivery date estimation model may be estimated based on this boundary.

Table 2 illustrates an example of learning data (pairs of input data and correct answer data). The input data is represented as converted numeric data. The company name is represented as identification information. Table 2 illustrates an example where a part of the order information is used as the input data.

TABLE 2

| | Input Data | | | | | Correct Answer Data | |
|---|---|---|---|---|---|---|---|
| | | | Desired | | Accepted | | Acceptable |
| ID | Company | Desired | Delivery | Accepted | Delivery | Acceptable | Delivery |
| No. | Name | Price | Date | Price | Date | Price | Date |
| 0001 | 1005 | 400 | 60 | 350 | 65 | 350-450 | 1-70 |
| 0002 | 8563 | 500 | 90 | 520 | 70 | 450-550 | 1-90 |

. . .

| | | | | | | | |
|---|---|---|---|---|---|---|---|
| M | 3521 | 1000 | 30 | 800 | 30 | 800-1200 | 1-35 |

### Inference Phase of Acceptable Price/Delivery Date Estimation Unit

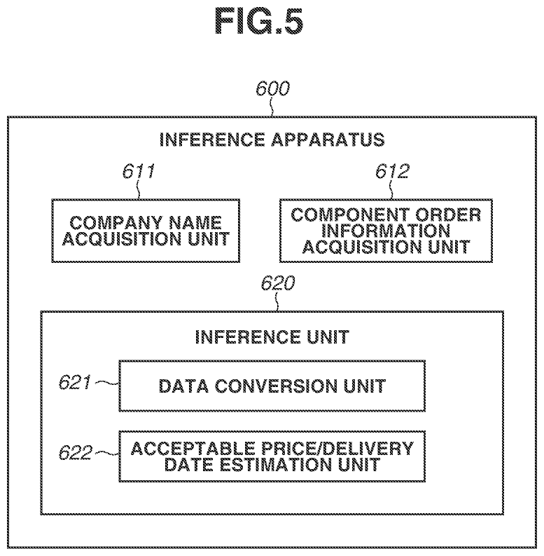

FIG. 5 is a block diagram illustrating a functional configuration of an acceptable price/delivery date estimation unit inference apparatus 600 corresponding to the acceptable price/delivery date estimation unit 122. The acceptable price/delivery date estimation unit inference apparatus 600 includes a company name acquisition unit 611, a component order information acquisition unit 612, and an inference unit 620. The inference unit 620 includes a data conversion unit 621 and an acceptable price/delivery date estimation unit 622. FIG. 18B illustrates a series of processing flows of inference processing to be performed by the acceptable price/delivery date estimation unit 122.

In step S1810, the company name acquisition unit 611 acquires the name of the company that has placed an order for estimation. The company name acquisition unit 611 may acquire identification information instead of the company name, as long as the company can be identified based on the identification information. For example, the identification information may be a corporation number or the like, or may be a number set by the company that performs the estimation.

In step S1811, the component order information acquisition unit 612 acquires component order information. In this case, the component order information includes a desired price and a desired delivery date of the component. The component order information may also include a price priority and a delivery date priority.

In step S1812, the data conversion unit 621 in the inference unit 620 converts the company name and component order information, which are received as input data, into numeric data. In step S1813, the acceptable price/delivery date estimation unit 612 outputs the acceptable price/delivery date estimated width to the above-described trained model, based on the input converted data. In this case, the acceptable price/delivery date estimation unit 612 uses the acceptable price/delivery date estimation model generated by the acceptable price/delivery date estimation model generation unit 422. Further, the output acceptable price/delivery date estimated width is adjusted depending on the price priority and the delivery date priority. At the learning phase described above, the price priority and the delivery date priority may be added as input data and may be reflected in the acceptable price/delivery date estimated width output from the acceptable price/delivery date estimation unit 612. At this learning phase, data indicating the accepted price or the expected price at which the order may have been received if the order has failed to be received by the company and the accepted delivery date or the expected delivery date for which the order may have been received if the order has failed to be received by the company may be used as the correct answer data.

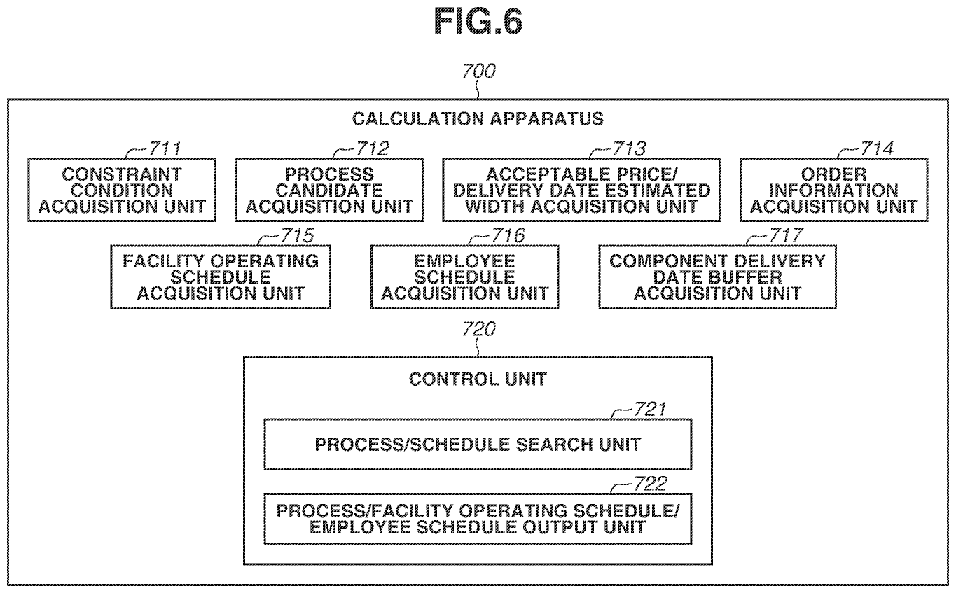

Processing to be executed by the process/schedule calculation unit 123 in the control unit 120 will now be described in detail. FIG. 6 is a block diagram illustrating a functional configuration of a process/schedule calculation apparatus 700 for the process/schedule calculation unit 123 according to the present example embodiment. The process/schedule calculation unit 123 may be composed of a CPU or the like. In the following description, the process/schedule calculation apparatus 700 includes a constraint condition acquisition unit 711, a process candidate acquisition unit 712, and an acceptable price/delivery date estimated width acquisition unit 713. The process/schedule calculation apparatus 700 also includes an order information acquisition unit 714, a facility operating schedule acquisition unit 715, an employee schedule acquisition unit 716, a component delivery date buffer acquisition unit 717, and a control unit 720. The control unit 720 includes a process/schedule search unit 721 and a process/facility operating schedule/employee schedule output unit 722. The constraint condition acquisition unit 711 may be shared with the constraint condition acquisition unit 112 illustrated in FIG. 1. The order information acquisition unit 714 may be shared with the order information acquisition unit 111 illustrated in FIG. 1. The facility operating schedule acquisition unit 715 may be shared with the facility operating schedule acquisition unit 113 illustrated in FIG. 1. The employee schedule acquisition unit 716 may be shared with the employee schedule acquisition unit 114 illustrated in FIG. 1.

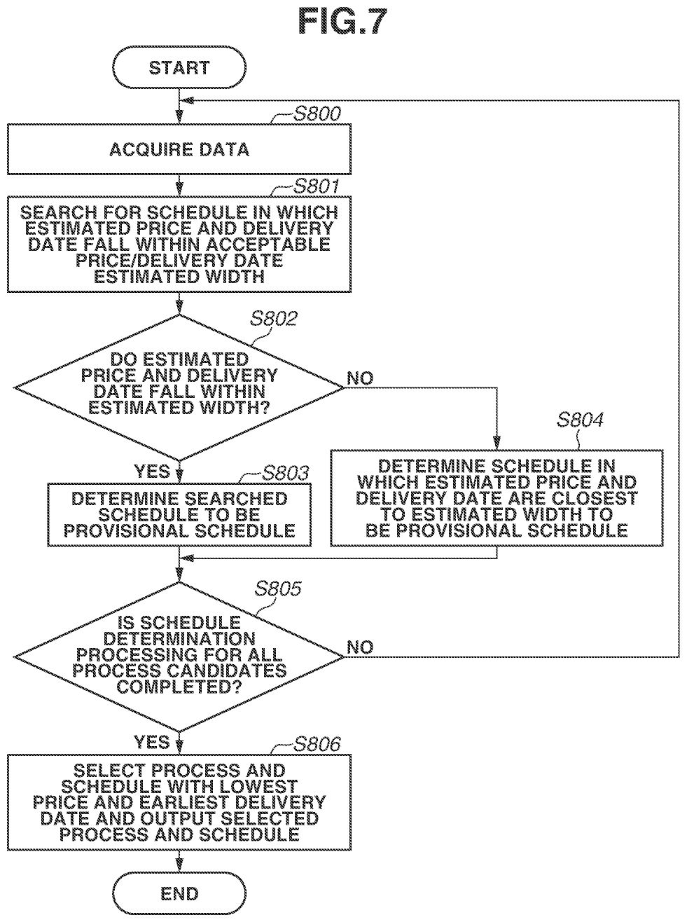

FIG. 7 is a flowchart illustrating a processing procedure for the process/schedule calculation apparatus 700. In step S800, the process/schedule calculation apparatus 700 acquires various data. Specifically, the various data include data on constraint conditions, the process candidate pattern calculated by the process candidate calculation unit inference apparatus 300, and data on the acceptable price/delivery date estimated width estimated by the acceptable price/delivery date estimation unit inference apparatus 600. The various data further include order information, a facility operating schedule, an employee schedule, and component delivery date buffer data.

In step S801, the process/schedule calculation apparatus 700 searches for a facility operating schedule and an employee schedule in which the estimated price and the estimated delivery date fall within the acceptable price/delivery date estimated width for each process candidate pattern. Constraint conditions used in this case include information indicating a correspondence between a facility and a process, a facility capability, information indicating a correspondence between an employee and a process, an employee capability, a cost per unit time of each facility, and a cost per unit time of each employee. Further, the process/schedule calculation apparatus 700 checks a status indicating an open slot in each of the facility operating schedule acquired by the facility operating schedule acquisition unit 715 and the employee schedule acquired by the employee schedule acquisition unit 716, and the searched schedule is incorporated in the open slot. If the customer importance in the order information acquired by the order information acquisition unit 714 is input and the component delivery date buffer acquired by the component delivery date buffer acquisition unit 717 is also input, the following processing is performed: the already set facility operating schedule and employee schedule are changed in the component delivery date buffer, and a schedule is searched by giving priority to manufacturing of the ordered component.

In step S802, the process/schedule calculation apparatus 700 determines whether the searched estimated price and delivery date fall within the acceptable price/delivery date estimated width. If the estimated price and delivery date fall within the acceptable price/delivery date estimated width (YES in step S802), the processing proceeds to step S803. If the estimated price and delivery date do not fall within the acceptable price/delivery date estimated width (NO in step S802), the processing proceeds to step S804.

In step S803, the process/schedule calculation apparatus 700 determines the searched schedule to be a provisional schedule in one process candidate pattern.

In step S804, the process/schedule calculation apparatus 700 determines the schedule in which the searched estimated price and delivery date are closest to the acceptable price/delivery date estimated width to be a provisional schedule in one process candidate pattern.

In step S805, the process/schedule calculation apparatus 700 checks whether the schedule determination processing is performed on all the process candidate patterns. In other words, the process/schedule calculation apparatus 700 performs schedule determination processing on all the process candidate patterns acquired by the process candidate acquisition unit 712. If the processing is not completed (NO in step S805), the processing returns to step S800. If the processing is completed (YES in step S805), the processing proceeds to step S806.

In step S806, the process/schedule calculation apparatus 700 selects a lowest estimated price and a shortest estimated process from among the estimated prices and delivery dates calculated based on all the process candidate patterns. The process/schedule calculation apparatus 700 then outputs a manufacturing schedule including the selected process, and a facility operating schedule and employee schedule corresponding to the manufacturing schedule.

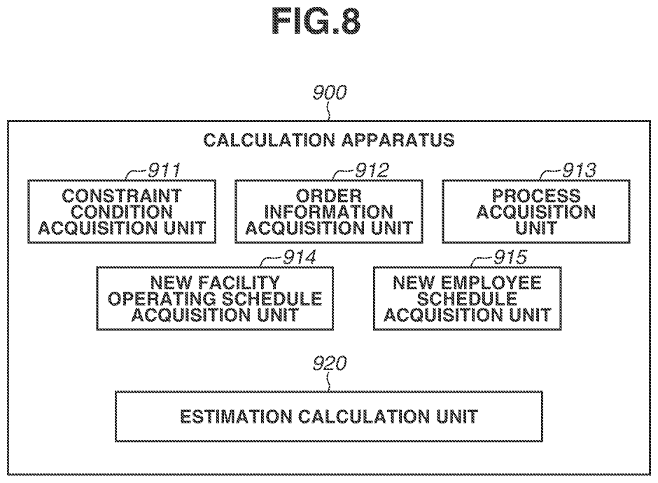

Processing to be executed by the estimation calculation unit 124 in the control unit 120 will now be described in detail. FIG. 8 is a block diagram illustrating a functional configuration of an estimation calculation apparatus 900 in the estimation calculation unit 124 according to the present example embodiment. The estimation calculation apparatus 900 includes a constraint condition acquisition unit 911, an order information acquisition unit 912, a process acquisition unit 913, a new facility operating schedule acquisition unit 914, a new employee schedule acquisition unit 915, and an estimation calculation unit 920. The constraint condition acquisition unit 911 may be shared with the constraint condition acquisition unit 112 illustrated in FIG. 1. The order information acquisition unit 912 may be shared with the order information acquisition unit 111 illustrated in FIG. 1.

The estimation calculation apparatus 900 acquires, using the constraint condition acquisition unit 911, data on information indicating a correspondence between a facility and a process, data on information indicating a correspondence between an employee and a process, data on a cost per unit time of each facility, and data on a cost per unit time of each employee. The estimation calculation apparatus 900 acquires, using the process acquisition unit 913, the process calculated by the process/schedule calculation unit 123.

The estimation calculation apparatus 900 calculates a processing cost for each process calculated by the process/schedule calculation unit 123. In this case, the processing cost is calculated as follows. First, the corresponding facility cost for each process is calculated by multiplying a facility operating time stored in process information by a cost per unit time of each facility. Further, the cost of each employee for each process is calculated by multiplying an employee operating time stored in process information by a cost per unit time of each employee. A processing cost for each process is then calculated by adding the facility cost and the employee cost for each process. Lastly, the total of processing costs of all processes is obtained to determine the processing cost for manufacturing the component.

The estimation calculation apparatus 900 then calculates a material cost. In this case, the material cost is calculated based on the 3D model in the order information acquired by the order information acquisition unit 912 and the material in the functional information. Specifically, the material cost is calculated based on the required shape and size for processing.

The estimation calculation apparatus 900 then determines a transportation cost. In this case, the transportation cost is calculated based on the company name and delivery destination included in the order information acquired by the order information acquisition unit 912. The transportation cost is calculated depending on the type of a transportation unit (e.g., a railway, an aircraft, a ship, or an automobile). Alternatively, the transportation cost may be determined depending on, for example, the complexity of the shape and the strength of the material.

The estimation calculation apparatus 900 then outputs the estimated price based on the processing cost, the transportation cost, and the material cost. In this case, the estimated price may be calculated by multiplying a certain coefficient by the total cost, including the processing cost, the transportation cost, and the material cost, or by adding a certain value to the total cost. Each of the processing cost, the transportation cost, and the material cost may be calculated by multiplying a certain coefficient by each of the processing cost, the transportation cost, and the material cost, or by adding a certain value to each of the processing cost, the transportation cost, and the material cost.

Lastly, the new facility operating schedule acquisition unit 914 and the new employee schedule acquisition unit 915 acquire the schedule calculated by the process/schedule calculation unit 123, and determine the estimated delivery date for manufacturing the component based on the schedule. In this case, the estimated delivery date may be calculated by multiplying a certain coefficient by the manufacturing date determined based on the schedule, or by adding a certain number of days to the manufacturing date.

Since the estimated price and the estimated delivery date are determined in consideration of the facility operation status and the employee status as described above, the estimated price and the estimated delivery date can be determined with high accuracy.

The above-described example embodiment illustrates an example where the employee schedule and the facility operating schedule, which vary from hour to hour, are not used as the input data in the learning processing. However, the present disclosure is not limited to this example. That is, the employee schedule and the facility operating schedule may be used as the input data in the learning processing on the acceptable price/delivery date estimation model.

### APPLICATION EXAMPLES

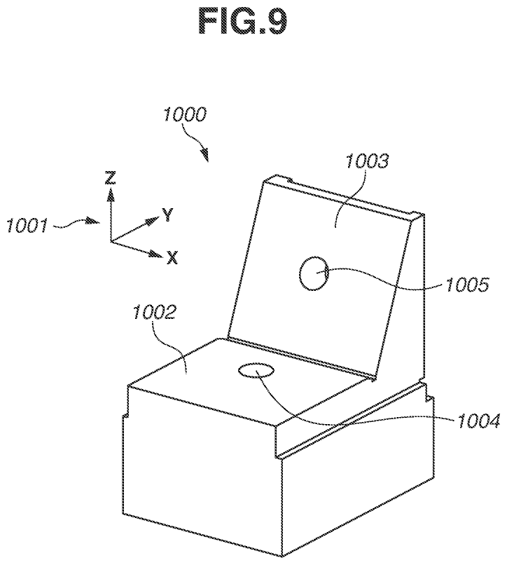

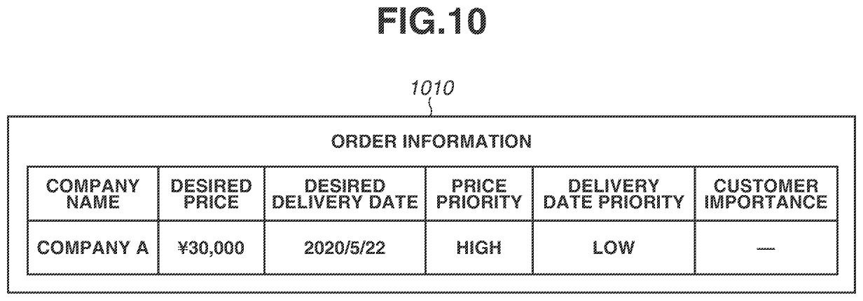

Application examples of the system 100 will be described. The order information acquisition unit 111 acquires data indicating a CAD model representing the shape of a component, component functional information, a company name, a desired price, a desired delivery date, a price priority, a delivery date priority, and a customer importance. FIG. 9 illustrates an example of the CAD model. FIG. 10 is a table illustrating an example of other order information. A CAD model 1000 illustrated in FIG. 9 is generated using a coordinate system represented as an XYZ coordinate system 1001. A plane 1002 on which the normal direction corresponds to a Z+direction includes holes 1004. A slope 1003 includes holes 1004. The price priority and the delivery date priority in order information 1010 are represented by “high”, “middle”, and “low”. The price priority illustrated in FIG. 10 is “high” and the delivery date priority illustrated in FIG. 10 is “low”.

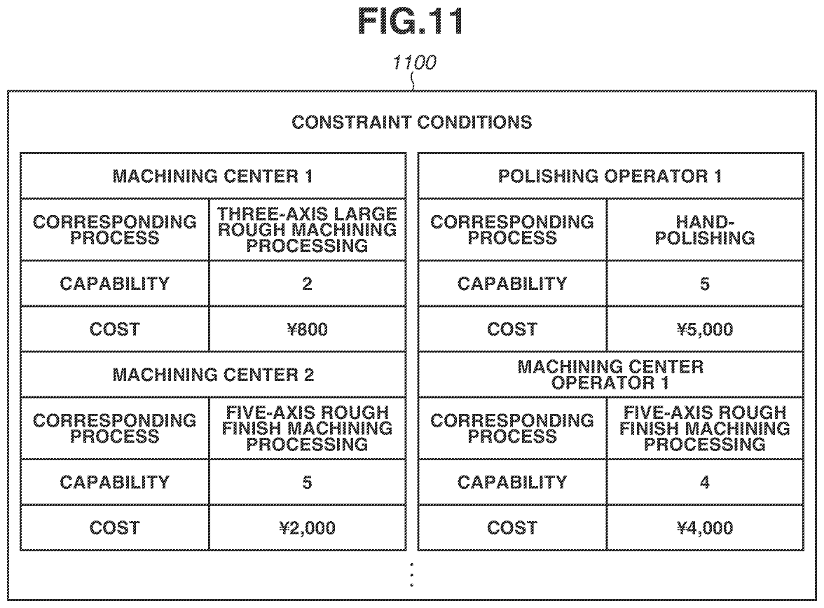

The constraint condition acquisition unit 112 acquires information indicating a correspondence between a facility and a process, a facility capability, information indicating a correspondence between an employee and a process, an employee operation capability, a cost per unit time of each facility, and a cost per unit time of each employee. FIG. 11 is a table illustrating an example of constraint conditions. FIG. 11 illustrates constraint conditions 1100 for each facility and each employee. The facility capability and the employee operation capability are determined based on five levels as relative values.

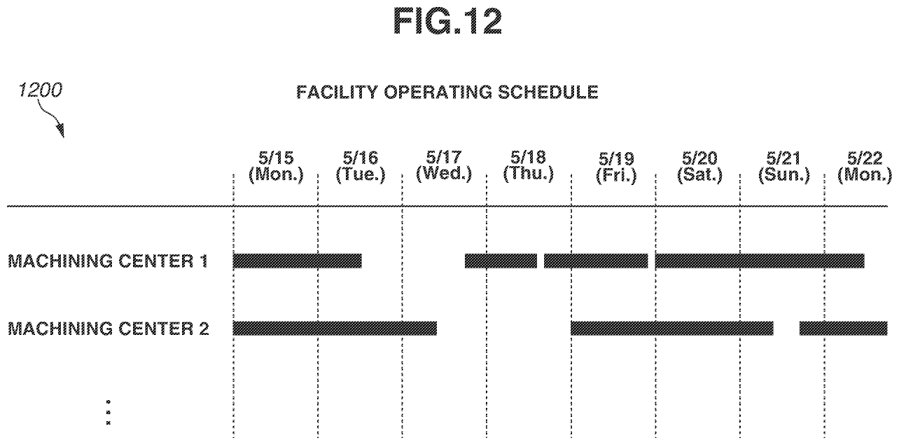

The facility operating schedule acquisition unit 113 then acquires the current and future operating schedules for each facility. FIG. 12 illustrates an example of the facility operating schedule. A facility operating schedule 1200 represents an everyday operating schedule for each facility.

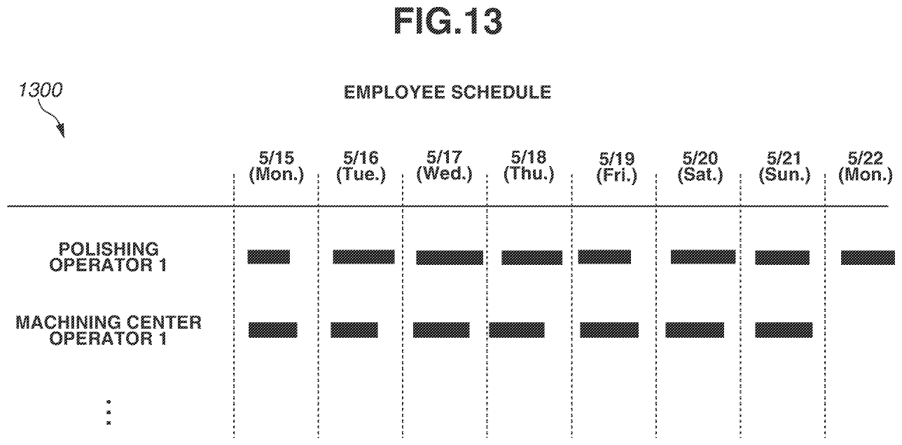

The employee schedule acquisition unit 114 acquires an employee work schedule and work plan. FIG. 13 illustrates an example of the employee schedule. An employee schedule 1300 represents an everyday operating time schedule for each employee.

Processing to be executed by the process candidate calculation unit 121 in the control unit 120 will now be described in detail. The process candidate calculation unit 121 assumes that the corresponding learning apparatus has already completed the learning processing. More specifically, the CAD model acquisition unit 211 acquires about 10,000 CAD models each representing the shape of the component stored in the order database 130, and the functional information acquisition unit 212 acquires the component functional information acquired by the CAD model acquisition unit 211. The data conversion unit 221 in the learning unit 220 then converts the acquired component CAD model into point group data, and converts the functional information into numeric data. The process candidate calculation unit 222 subsequently uses deep learning to output a process pattern candidate and a required time for each process in each process pattern for the input point group data and numeric data. The process correct answer input unit 223 compares the actual data stored in the order database 130 as a correct answer with the process pattern candidate and the required time for each process output from the process candidate calculation unit 222. The difference obtained by the comparison is learned by the back propagation method, and the weight of each node in the deep learning model is updated.

In the process candidate calculation unit inference apparatus 300, the CAD model acquisition unit 311 acquires the CAD model 1000, and the functional information acquisition unit 312 acquires the functional information about the CAD model 1000. The data conversion unit 321 in the inference unit 320 converts the CAD model 1000 into point group data and converts the functional information about the CAD model 1000 into numeric data. Lastly, the process candidate calculation unit 322 receives the point group data and numeric data for the deep learning model on which the learning processing is completed by the learning unit 220 in the process candidate calculation unit learning apparatus 200. The process candidate calculation unit 322 thereby outputs the required time for each process candidate pattern, each process pattern, and each process.

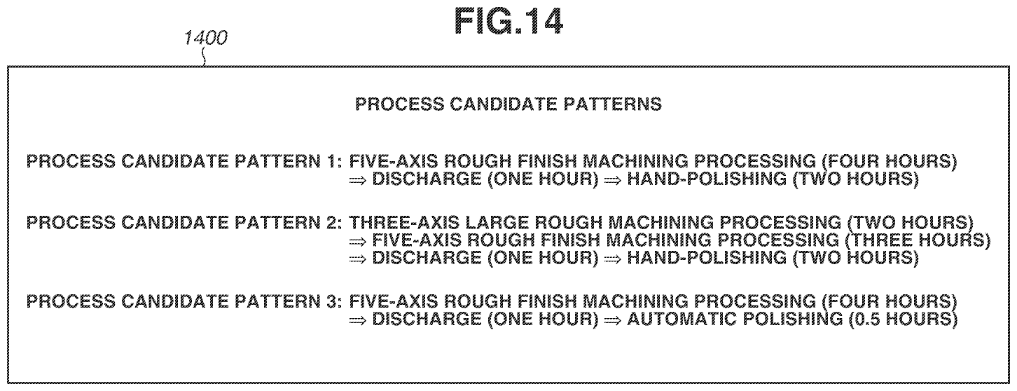

FIG. 14 illustrates an example of the required time for each process candidate pattern, each process pattern, and each process in the CAD model 1000. FIG. 14 illustrates three process candidate patterns 1400, and the required time for each process in each process candidate pattern is output.

As for the acceptable price/delivery date estimation unit 122 in the control unit 120, the acceptable price/delivery date estimation unit learning apparatus 400 generates the inference unit 620 as follows. That is, the inference unit 620 is generated by preliminarily classifying, by using logistic regression, a desired price, a desired delivery date, information indicating whether an order is received, a responded price, a responded delivery date, an accepted price, an accepted delivery date, and a reason for failure to receive an order, of each component for which an order is previously placed in each company.

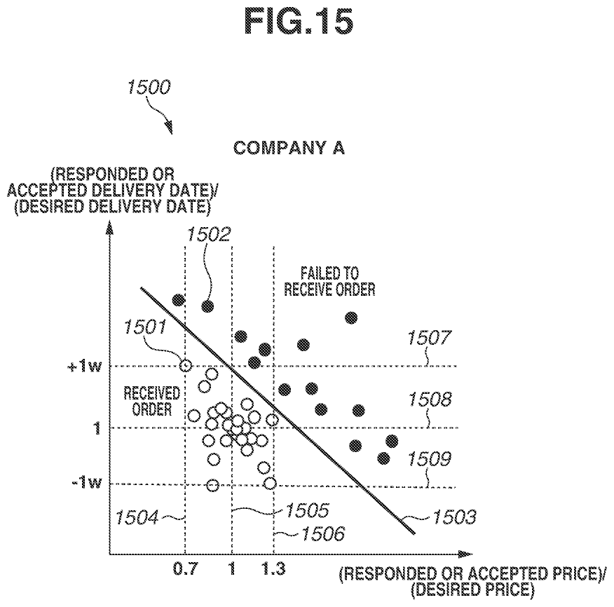

FIG. 15 is a graph illustrating an acceptable price/delivery date estimation model for company A. An acceptable price/delivery date estimation model 1500 is defined by two axes: the first axis representing a value obtained by dividing a responded or accepted price by a desired price, and the second axis representing a value obtained by subtracting a responded or accepted delivery date from a desired delivery date. In FIG. 15, each white point 1501 represents previous order recording, each black point 1502 represents recording of a previous failure to receive an order, and a boundary 1503 indicates a boundary between a case of receiving an order and a case of failing to receive an order. This boundary is obtained by machine learning. An axis 1504 indicates that (responded or accepted price)/(desired price) equals 0.7. An axis 1505 indicates that (responded or accepted price)/(desired price) equals 1. An axis 1506 indicates that (responded or accepted price)/(desired price) equals 1.3. It can be seen that orders have been received when (previously responded or accepted price)/(desired price) is in a range from 0.7 to 1.3, and many orders have been received when (previously responded or accepted price)/(desired price) equals 1. An axis 1507 indicates a case where the responded or accepted delivery date is one week behind the desired delivery date. An axis 1508 indicates a case where the desired delivery date matches the responded or accepted delivery date. An axis 1509 indicates a case where the responded or accepted delivery date is one week earlier than the desired delivery date. It can be seen that orders have been received when the previously responded or accepted delivery date is within a range of one week ahead and behind the desired delivery dates, and many orders have been received when the desired delivery date matches the responded or accepted delivery date. As described above, the acceptable price/delivery date estimated width for company A corresponds to the range surrounded by the axes 1504, 1506, 1507, and 1509, and the boundary 1503. The data conversion unit 621 in the inference unit 620 then converts the company A as the company name included in the input data, and the desired price and the desired delivery date, which are the component order information, into numeric data. Further, the acceptable price/delivery date estimation unit 622 outputs the numeric data to the acceptable price/delivery date estimation model 1500. The acceptable price/delivery date estimation unit 622 then outputs the acceptable price estimated width of 21,000 yen to 39,000 yen, the delivery date estimated width of May 15 to May 29, 2020, and a combination of a price and a delivery date that do not exceed the boundary 1503. Since the price priority is higher than the order information, the acceptable price estimated width is further adjusted to width of 21,000 yen to 33,000 yen. Since the delivery date priority is low, the acceptable delivery date estimated width is further adjusted from May 15 to May 31, 2020 as the range not exceeding the boundary 1503 of the acceptable price/delivery date estimation model 1500.

The process/schedule calculation apparatus 700 subsequently determines a process candidate pattern 2 illustrated in FIG. 14 to be a process based on a combinatorial optimization problem, and outputs the schedule corresponding to the process. Specifically, the process/schedule calculation apparatus 700 uses, for the combinatorial optimization problem, the order information illustrated in FIG. 10, the constraint conditions illustrated in FIG. 11, the facility operating schedule illustrated in FIG. 12, and the employee schedule illustrated in FIG. 13. The process/schedule calculation apparatus 700 also uses the process candidate and the acceptable price/delivery date estimated width. The process candidate has been calculated by the process candidate calculation unit inference apparatus 300 illustrated in FIG. 14. The acceptable price/delivery date estimated width has been output from the acceptable price/delivery date estimation unit inference apparatus 600. In this case, the process candidate pattern 2 uses a machining center 1 for three-axis large rough machining processing in a first process, and the processing time for five-axis rough finish machining processing is short, and thus the cost of the processing is lower than that of the other process candidate patterns. Furthermore, the machining center 1 is available on May 16 and 17 according to the facility operating schedule 1200, and thus the processing can be immediately performed. For this reason, the process candidate pattern 2 is adopted.

The estimation calculation apparatus 900 determines an estimated price. Here, the estimation calculation apparatus 900 calculates the processing cost based on the constraint conditions illustrated in FIG. 11 and the process determined by the process/schedule calculation apparatus 700, and the material cost and the transportation cost based on the order information. The estimation calculation apparatus 900 then calculates the estimated price as \29,000.

Lastly, the new facility operating schedule acquisition unit 914 and the new employee schedule acquisition unit 915 acquire the schedule determined in the process/schedule calculation apparatus 700, and determine the estimated delivery date for manufacturing the component to be “May 20, 2020” based on the schedule.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like. The processors or circuits can include a CPU, a micro processing unit (MPU), a GPU, an ASIC, and an FPGA. The processors or circuits can also include a digital signal processor (DSP), a data flow processor (DFP), and a neural processing unit (NPU).

While some embodiments of the present disclosure have been described with reference to example embodiments, it is to be understood that the invention is not limited to the disclosed example embodiments. The scope of the following claims is to be accorded the broadest interpretation so as to encompass all such modifications and equivalent structures and functions.

This application claims the benefit of Japanese Patent Application No. 2020-178931, filed Oct. 26, 2020, which is hereby incorporated by reference herein in its entirety.

What is claimed is:

1. A system comprising:
an acquisition unit configured to acquire order information about an article, information for identifying an operation status of a facility used to manufacture the article, and information for identifying a status of an employee to engage in the manufacturing of the article; and
an output unit configured to output information indicating an estimated price and an estimated delivery date in a case where the article is manufactured in the facility based on the order information about the article, the information for identifying the operation status of the facility used to manufacture the article, and the information for identifying the status of the employee to engage in the manufacturing of the article, the order information, the information for identifying the operation status, and the information for identifying the status of the employee being acquired by the acquisition unit.

2. The system according to claim 1, wherein the output unit includes:
a first output unit configured to output information for identifying a manufacturing schedule for manufacturing the article in the facility based on the order information about the article, the information for identifying the operation status of the facility used to manufacture the article, and the information for identifying the status of the employee to engage in the manufacturing of the article, the order information, the information for identifying the operation status, and the information for identifying the status of the employee being acquired by the acquisition unit; and
a second output unit configured to output information indicating the estimated price and the estimated delivery date in a case where the article is manufactured in the facility based on the information for identifying the manufacturing schedule for manufacturing the article in the facility, information for identifying a cost per unit time of a facility to be used for the manufacturing of the article, and information for identifying a cost per unit time of an employee to engage in the manufacturing of the article, the information for identifying the manufacturing schedule being output from the first output unit.

3. The system according to claim 2, wherein the first output unit outputs the information for identifying the manufacturing schedule for manufacturing the article in the facility based on the order information about the article, the information for identifying the operation status of the facility used to manufacture the article, the information for identifying the status of the employee to engage in the manufacturing of the article, and a trained model, the order information, the information for identifying the operation status, and the information for identifying the status of the employee being acquired by the acquisition unit.

4. The system according to claim 3, wherein the first output unit outputs the information for identifying the manufacturing schedule for manufacturing the article in the facility based on information output by inputting the order information about the article to the trained model, the information for identifying the operation status of the facility used to manufacture the article, and the information for identifying the status of the employee to engage in the manufacturing of the article.

5. The system according to claim 4, wherein the information for identifying the manufacturing schedule for manufacturing the article in the facility is selected from a manufacturing schedule inferred using previous article order information as input data and using a trained model obtained by learning information for identifying a previous manufacturing schedule as correct answer data.

6. The system according to claim 1, wherein the order information about the article includes information for identifying a shape of the article and information for identifying a function of the article.

7. The system according to claim 1, wherein the order information about the article includes at least one of information for identifying a shape of the article, information for identifying a function of the article, information for identifying a company to place an order, information for identifying a price priority, or information for identifying a delivery date priority.

8. A control method to be executed by an apparatus in a system configured to output an estimated price and an estimated date in a case where an article is manufactured based on order information about the article, the control method comprising:
acquiring the order information about the article, information for identifying an operation status of a facility used to manufacture the article, and information for identifying a status of an employee to engage in the manufacturing of the article; and
outputting the estimated price and the estimated date in a case where the article is manufactured in the facility based on the acquired order information about the article, the acquired information for identifying the operation status of the facility used to manufacture the article, and the acquired information for identifying the status of the employee to engage in the manufacturing of the article.

9. A non-transitory computer-readable storage medium storing a program for causing a computer to execute a control process to be executed by an apparatus in a system configured to output an estimated price and an estimated date in a case where an article is manufactured based on order information about the article, the control process comprising:
acquiring the order information about the article, information for identifying an operation status of a facility used to manufacture the article, and information for identifying a status of an employee to engage in the manufacturing of the article; and
outputting the estimated price and the estimated date in a case where the article is manufactured in the facility based on the acquired order information about the article, the acquired information for identifying the operation status of the facility used to manufacture the article, and the acquired information for identifying the status of the employee to engage in the manufacturing of the article.
